(19) United States
(12) Patent Application Publication
(10) Pub. No.: US 2014/0308644 A1
(43) Pub. Date: Oct. 16, 2014

(54) Foreign Body Removal System

(71) Applicant: Lillian ING LING Wang, Moraga, CA (US)

(72) Inventor: Lillian ING LING Wang, Moraga, CA (US)

(21) Appl. No.: 14/254,766

(22) Filed: Apr. 16, 2014

Related U.S. Application Data
(60) Provisional application No. 61/812,668, filed on Apr. 16, 2013.

(51) Int. Cl. G09B 23/30

(52) U.S. Cl. CPC G09B 23/30
USPC 434/271

(57) ABSTRACT

A system and method for the practice of removing foreign objects from a human eye. The system can be mounted onto a biomicroscope such that a trainee can utilize the device to practice careful removal of foreign objects on or embedded in an artificial eyeball.

### CLAIM OF PRIORITY

The following application claims priority to U.S. Provisional Patent Application No. 61/812,668, filed Apr. 16, 2013, the complete contents of which are hereby incorporated by reference.

### BACKGROUND

1. Field Of The Invention

The present disclosure relates to the field of medical equipment, specifically a system for practicing the removal of foreign objects from an eyeball or other body part.

2. Background

The human eye is a very delicate part of the body, susceptible to injury and illness if care and caution are not exercised. However, inevitably both children and adults alike can find themselves in a situation where foreign objects, such as splinters, sand, rocks, or small glass fragments, can enter the eye and cause discomfort, damage, or in extreme cases even blindness. In the event of an accident where a foreign body has entered the eye and attached or embedded in the eyeball, it is necessary to remove the object as quickly and carefully as possible to prevent further damage. Therefore, clinicians must be well-trained in the removal of such objects.

What is needed is system for practicing and becoming proficient in removal of foreign objects from a human eye, without needing actual human subjects for such practice. The system should provide an artificial eyeball coupled with a retainer unit that can selectively attach to a biomicroscope. In some embodiments, the artificial eyeball can be gelatinous, multilayered, and multicolored to resemble the material, elasticity, and anatomy of a human eyeball. In further embodiments, the system can be combined with one or more implements to create a complete kit for the practice of removing foreign objects from a human eye.

### BRIEF DESCRIPTION OF THE DRAWINGS

FIG. 1A depicts a perspective view of one embodiment of the current system.

FIG. 1B depicts a front planar view of one embodiment of the current system comprising aperture protrusions.

FIG. 2A depicts a perspective view of one embodiment of a holding vessel 106 comprising attachment points.

FIG. 2B depicts an alternate embodiment of a holding vessel having a tubular configuration.

FIG. 3 depicts a side view of one embodiment of the current system mounted on a biomicroscope.

FIG. 4 depicts a front view of one embodiment of the current system mounted on a biomicroscope.

FIG. 5A depicts a planar view of the back surface of one embodiment of a retainer unit having adhesive attachment members.

FIG. 5B depicts a perspective view of one embodiment of a retainer unit having hook attachment members.

FIG. 5C depicts a perspective view of an alternate embodiment of a retainer unit having a substantially planar configuration culminating in curved top and bottom ends.

FIG. 6 depicts a perspective view of one embodiment of an artificial eyeball and a support member.

FIG. 7 depicts a perspective view of an alternate embodiment of an artificial eyeball and a support member.

FIG. 8 depicts a side cross-section view of one embodiment of a holding vessel having a sharp protrusion engaged with an artificial eyeball.

FIG. 9 depicts a perspective view of one embodiment of a foreign body removal system kit.

### DETAILED DESCRIPTION

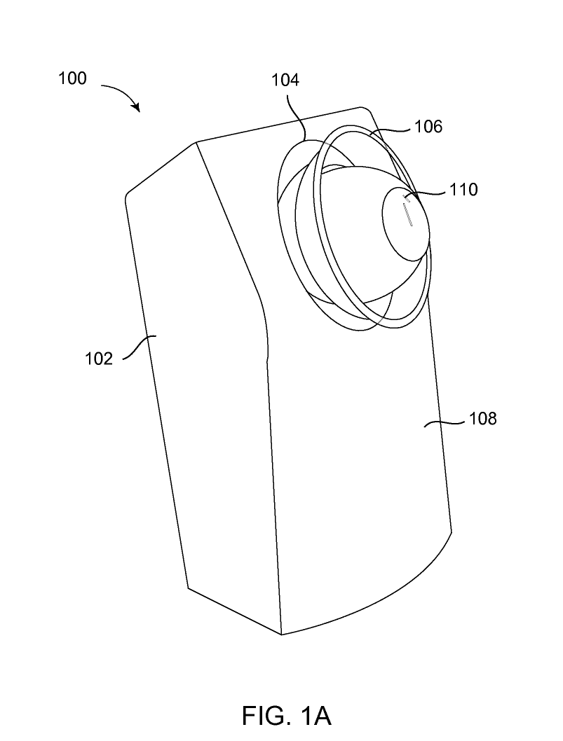

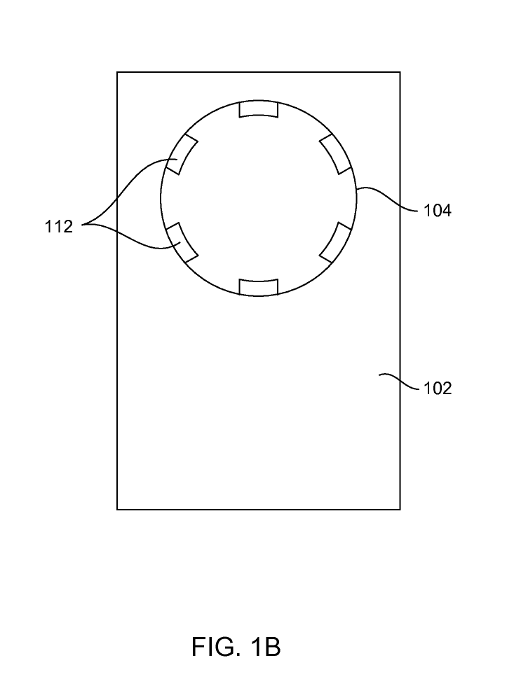

FIG. 1A depicts a perspective view of one embodiment of a foreign body removal system 100. A system 100 can comprise a retainer unit 102, an aperture 104, a holding vessel 106, a covering 108, and an artificial eyeball 110.

A retainer unit 102 can be a substantially cuboid member with a front surface, a back surface, and perimeter surfaces, as depicted in FIG. 1A. In other embodiments, a retainer unit 102 can have cylindrical, toroidal, planar, curved planar, and/or any other known and/or convenient geometry. In some embodiments, lateral and/or longitudinal cross-sections can reveal uniformity in shape and size throughout the body of a retainer unit 102, while in other embodiments a retainer unit 102 can have irregular or non-uniform geometrical cross-sections. In some embodiments, a retainer unit 102 can be solid throughout its body, while in other embodiments a retainer unit 102 can be hollow. Moreover, in some embodiments, a retainer unit 102 can have weighted portions to encourage correct orientation when in use.

A retainer unit 102 can be at least partially comprised of flexible, compressible, and/or elastomeric material, such that it can be selectively deformed before, during, or after use. Such material can be silicone, rubber, polymer and/or any other desired material or combination of materials. In other embodiments, a retainer unit 102 can be at least partially comprised of rigid or semi-rigid material, such that it can withstand a desired amount of force without deforming or becoming damaged. In such embodiments, material can be metal, wood, plastic, cardboard, and/or or any other desired material or combination of materials. Moreover, at least a portion of a retainer unit 102 can have a smooth surface, while in alternate embodiments a retainer unit 102 can have a surface with ridges, bumps, grooves, indentations, roughened texture, or any other known and/or convenient texture or surface characteristic. A retainer unit 102 can further comprise antibacterial, antimicrobial, antifungal, and/or nonslip coating or inherent properties. Further, a retainer unit 102 can have any desired color, combination of colors, or printed images. In some embodiments, instructions for use of the foreign body removal system 100 can be printed on the back surface of a retainer unit 102 or in any other desired location on the surface of a retainer unit 102.

In some embodiments, a retainer unit 102 can be disposable and/or designed for one-time use. In such embodiments, a retainer unit 102 can be pre-formed during manufacture and ready to use upon arrival at its end user. In alternate embodiments, a retainer unit 102 can arrive flat and/or disassembled and can be assembled and/or folded into proper configuration for use. In other embodiments, a retainer unit 102 can be reusable and/or can be adapted to withstand high temperatures and moisture levels, thereby allowing the retainer unit 102 to be sterilized in laboratory or clinical sterilizers.

In additional embodiments, a retainer unit 102 can further comprise a covering 108. A covering 108 can cover the front and back surfaces of a retainer unit 102 and can provide rigidity to an otherwise compressible retainer unit 102, as depicted in FIG. 1A. In other embodiments, a covering 108 can be flexible and/or can provide waterproofing to the retainer unit 102 and/or can act as a barrier to prevent unwanted substances from contaminating, staining, and/or damaging a retainer unit 102. A covering 108 can be comprised of plastic sheeting, silicone, or any other material or combination materials, and can be selectively removable and/or can cover any desired portion of a retainer unit 102. A covering 108 can further be configured to cover a holding vessel 106 if desired.

Referring to FIG. 1A, a retainer unit 102 can further comprise one or more apertures 104 configured to accept a holding vessel 106. In the embodiment depicted, an aperture 104 runs through the upper portion of the front surface of a retainer unit 102, but in other embodiments an aperture 104 can be located at any other desired location on a retainer unit 102. Moreover, in alternate embodiments a second aperture 104 can be located in the back surface of a retaining unit 102 or in any other desired location. An aperture 104 can be circular as shown or can have any other desired geometry. In some embodiments, the geometry of an aperture 104 may be different than that of a holding vessel 106, but the aperture 104 can still be capable of accommodating the holding vessel 106 in a desired position.

Referring to FIG. 1B, a retainer unit 102 can further comprise one or more protrusions 112 extending into an aperture 104. Protrusions 112 can provide added friction when in contact with a holding vessel 106. In other embodiments, one or more protrusions 112 can be configured to engage specific portions of the outer surface of a holding vessel 106 such that the holding vessel 106 can be selectively locked into place. Furthermore, in some embodiments the perimeter edge or edges of an aperture 104 can be reinforced for added durability. In yet alternate embodiments, a retainer unit 102 may be devoid of any apertures 104.

A foreign body removal system 100 can further comprise a holding vessel 106 configured to couple with a portion of a retainer unit 102. In instances where a retainer unit 102 is devoid of apertures 104, a holding vessel 106 can be coupled with a surface of a retainer unit 102 via adhesive, pins, hook and loop material, screws, nails, clips, snaps, and/or any other known and/or convenient device for or method of attachment. However, in embodiments containing at least one aperture 104, a holding vessel 106 can be selectively, removably, and/or fixedly attached to a retainer unit 102 via an aperture 104. In the embodiment shown in FIG. 1A, a holding vessel 106 can rest in an aperture 104 on the front surface of a retainer unit 102 such that the opening of the holding vessel 106 can be exposed, with the base of the holding vessel 106 extending below the front surface and toward the back surface of the retainer unit 102. In other embodiments, a holding vessel 106 can be coupled with a retainer unit 102 in any other desired configuration.

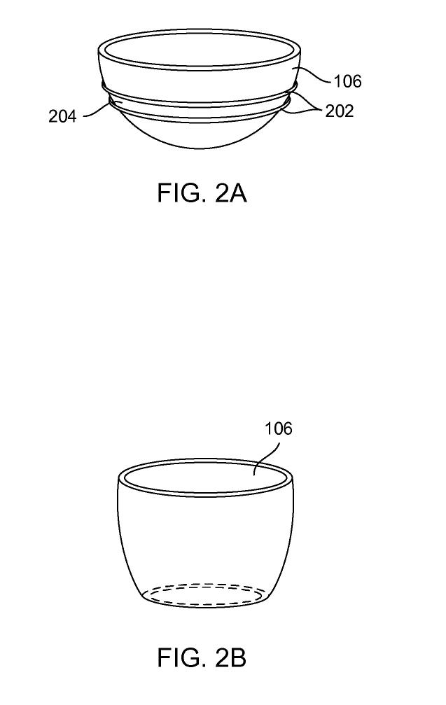

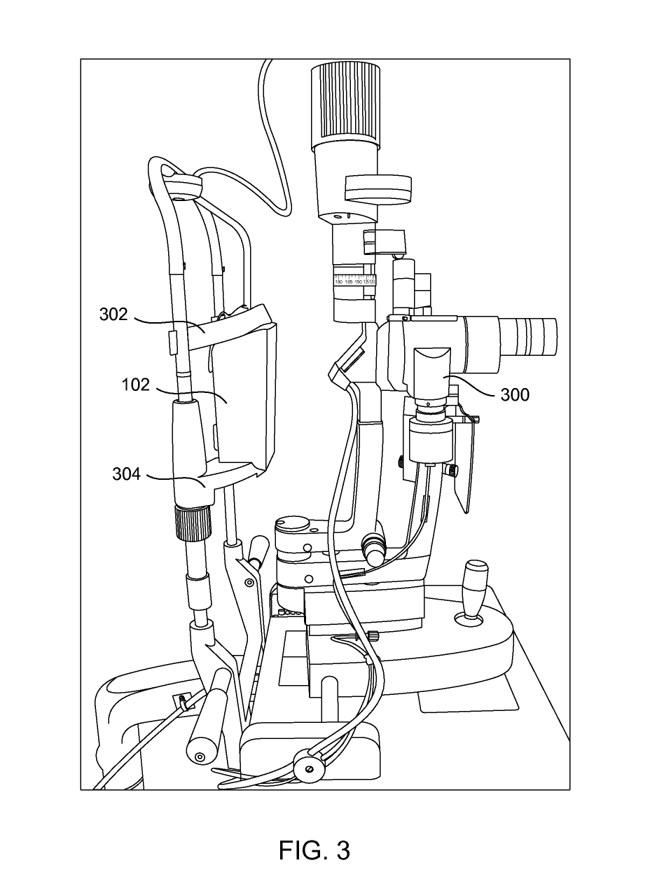

A holding vessel 106 can have a substantially bowl or cup-like geometry, as depicted in FIG. 2A, with one opening and a domed base. This configuration can allow an artificial eyeball 110 to rest inside and be substantially contained by the holding vessel 106. FIG. 2B depicts an alternate embodiment of a holding vessel 106 in which it can be substantially tubular and have a slightly tapered configuration. This configuration can provide easy access to an artificial eyeball 110 for purposes of installation, adjustment, or replacement. In yet further embodiments, a holding vessel 106 can be conical, cuboid, toroidal, or can have any other known and/or convenient geometry.

The interior surfaces of a holding vessel 106 can be smooth, grooved and/or textured. Texturing the interior surfaces of a holding vessel 106 can facilitate the insertion of an artificial eyeball 110 into the holding vessel 106 and provide friction to stabilize and position the artificial eyeball 110 in place. In other embodiments, the interior surfaces of a holding vessel 106 can have adhesive or sticky coating, pins or protrusions to anchor an artificial eyeball 110 in place, or any other desired characteristic.

Referring to FIG. 2A, a holding vessel 106 can have integrated attachment points 202 for coupling with a retainer unit 102. In the embodiment depicted, attachment points 202 comprise two circumferential ridges that create a groove 204 configured to engage the edges of an aperture 104. In further embodiments, attachment points 202 can be indentations, hooks, or have any other desired geometry or configuration and/or can complementarily mate with protrusions 112 (see FIG. 1B). Moreover, in some embodiments, a holding vessel 106 can selectively attach to a retainer unit 102 via an aperture 104 such that the open edge of the holding vessel 106 is flush with the front surface of the retainer unit 102. In yet further embodiments, a holding vessel 106 can be fixedly attached to a retainer unit 102, and/or a holding vessel 106 and a retainer unit 102 can be fabricated from a continuous piece of material.

A holding vessel 106 can be comprised of rigid material, such as wood, metal, or hard plastic. In other embodiments, a holding vessel 106 can be comprised of elastomeric material, such as silicone, rubber, polymer, or flexible plastics. In further embodiments, a holding vessel 106 can be comprised of a combination of rigid and elastomeric material, and/or can be comprised of any other known and/or convenient material. A holding vessel 106 can be reusable and/or adapted to withstand high temperatures and moisture levels in sterilization processes, while in other embodiments a holding vessel 106 can be disposable and/or designed for one-time use. Moreover, a holding vessel 106 can be configured to accept one or more different sizes of artificial eyeballs 110, to account for differing sizes of human eyeballs.

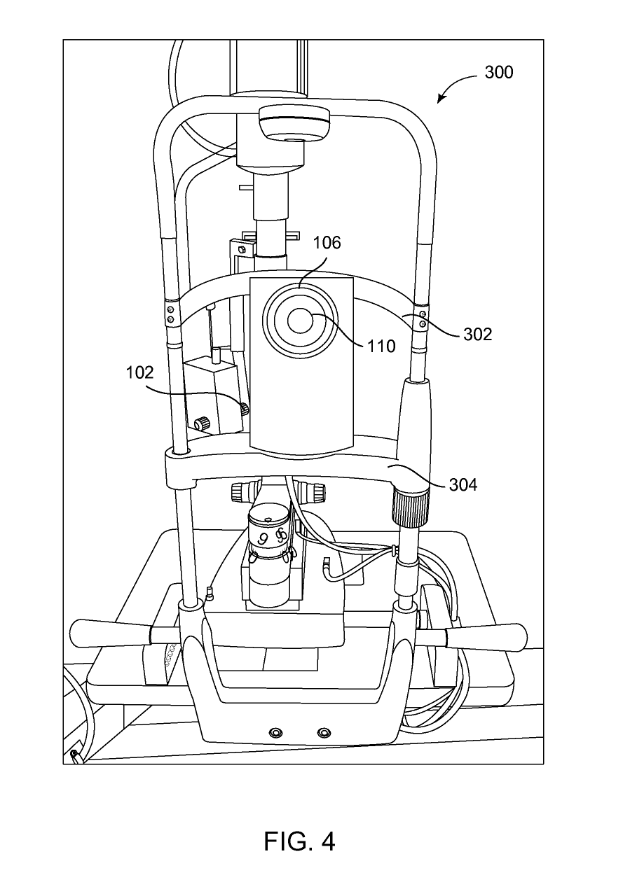

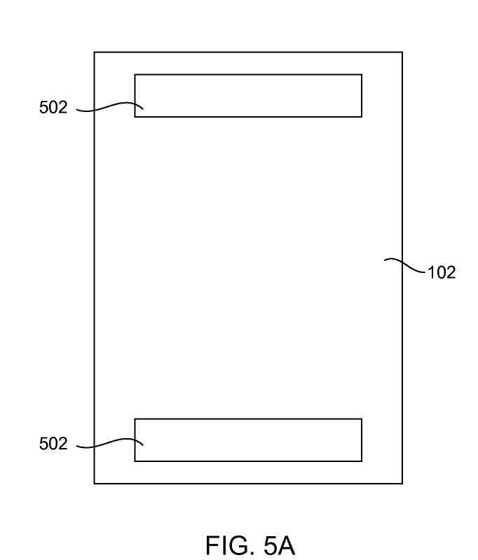

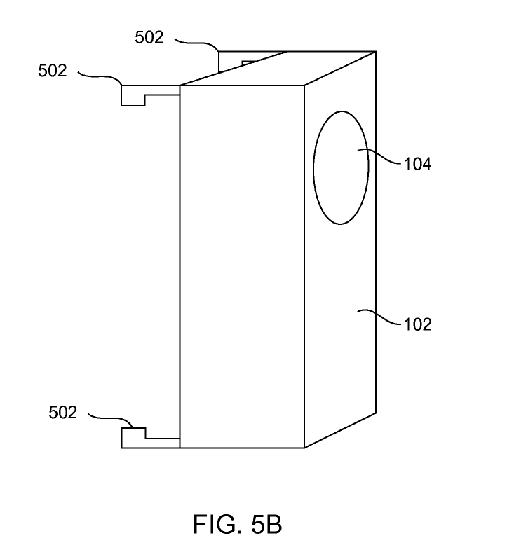

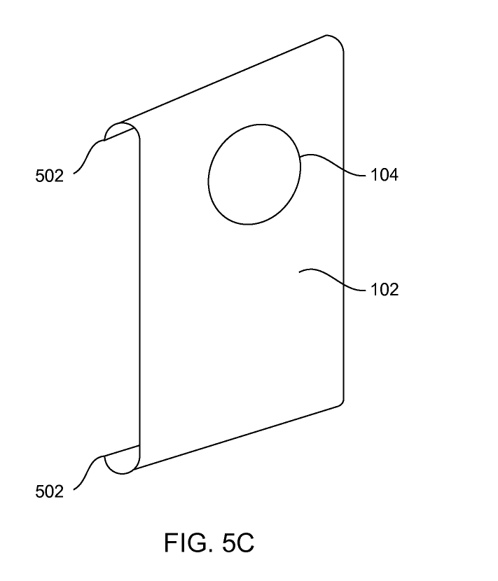

Referring to FIGS. 3-4, a retainer unit 102 can be configured for mounting onto a biomicroscope 300. In some embodiments, the headrest 302 and chinrest 304 of a biomicroscope 300 can be adjusted vertically, either manually or electronically, to hold a retainer unit 102 in position by exerting opposing forces on the top and bottom ends of the retainer unit 102. Referring to FIGS. 5A-C, in further embodiments one or more attachment members 502 can be coupled with the back surface of a retainer unit 102 and can be utilized to selectively, removably, and/or fixedly mount a retainer unit 102 on a biomicroscope 300. In other embodiments, attachment members 502 can be coupled with a retainer unit 102 in any other desired location. Attachment members 502 can be adhesive material as depicted in FIG. 5A or hooks as shown in FIG. 5B. In other embodiments, one or more attachment members 502 can be a strap, buckle, hook and loop material, snap, clamp, and/or any other known and/or convenient device. In yet further embodiments, a biomicroscope 300 can be dedicated solely to training others in removal of foreign bodies from an eye, and therefore a retainer unit 102 can be fixedly coupled with a headrest 302 and/or a chinrest 304 via screws or nails 502 and/or any other known and/or convenient method or device for attachment.

In yet further embodiments, attachment members 502 can be integral with the material of a retainer unit 102. FIG. 5C depicts a perspective view of a substantially planar retainer unit 102 culminating in curved top and bottom ends to form hooks 502. In such an embodiment, attachment members 502 and a retainer unit 102 can be one continuous piece of material. Attachment members 502 can be plastic, metal, wood, polymer, and/or any other known and/or convenient material. The size and geometry of an attachment member 502 can be determined based on standards of biomicroscope 200 design and/or via custom design for a particular biomicroscope 200. In some embodiments, attachment members 502 can be selectively adjustable and/or removable from a retainer unit 102, whereas in alternate embodiments attachment members 502 can be fixedly coupled with any desired portion of a retainer unit 102. In further embodiments, attachment members 502 need not be present.

A foreign body removal system 100 can further comprise an artificial eyeball 110, as depicted in FIGS. 1 and 6-8. An artificial eyeball 110 can be configured to closely resemble the anatomy and material of a human eyeball. In the embodiments depicted, an artificial eyeball 110 is substantially spherical, but in other embodiments an artificial eyeball 110 can be a half dome with a flat base or can have any other desired geometry. An artificial eyeball 110 can be comprised of one or more elastomeric and/or gelatinous materials corresponding to the anatomy of a human eyeball, such as the iris or layers of the cornea. The material of the artificial eyeball 110 can be silicone, polymer gel, or any other desired material or combination of materials. Moreover, in some embodiments, the base and/or another portion of the artificial eyeball 110 can be rigid or semi-rigid to provide structural integrity, stability, support, and/or enable proper mounting of the artificial eyeball 110 within a foreign body removal system 100.

Furthermore, the materials comprising an artificial eyeball 110 can have varying density and/or viscosity. For instance, in some embodiments the artificial corneal epithelium of the artificial eyeball 110 can be formed of a gelatinous material of greater density and increased surface tension than the body of the artificial eyeball 110. In keeping with the look and feel of a real human eyeball, an artificial eyeball 110 can have one or more colors corresponding to the iris, pupil, sclera, and other anatomical features. In some embodiments, these anatomical features can be represented by materials such as paper or plastic formed into a desired shape and placed within the material of the artificial eyeball 110. An artificial eyeball 110 can be disposable or designed for one-time use, while in other embodiments some or all components of an artificial eyeball 110 can reusable.

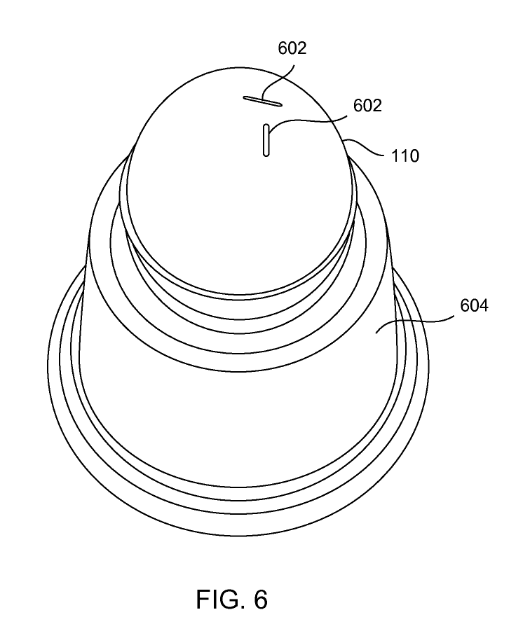

An artificial eyeball 110 can be embedded or configured to be embedded with one or more foreign bodies 602, as depicted in FIG. 6. Such foreign bodies 602 can be actual or simulated materials such as sand, rock, metal, wood, plastics, glass, or any other desired material or object. Dyes can be placed around foreign bodies 602 corresponding to simulated rust rings, surface irregularity and stagnant corneal epithelial cells. Foreign bodies 602 can be embedded within the artificial eyeball 110 during fabrication or can be inserted into the artificial eyeball 110 immediately prior to use in any desired location.

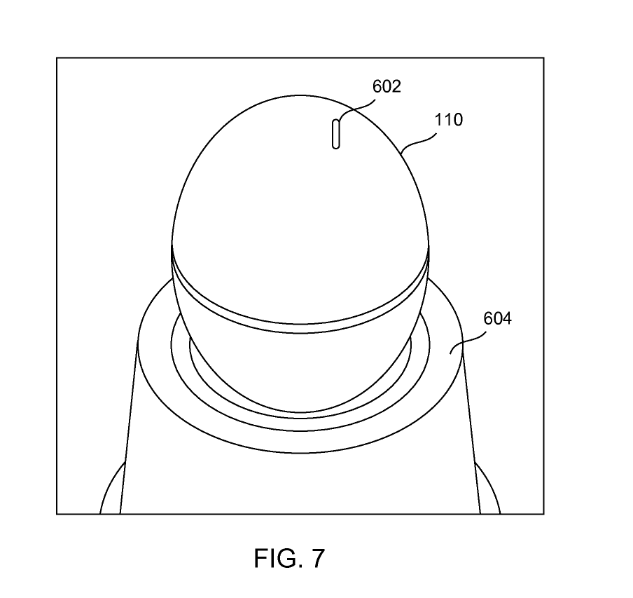

In some embodiments, a foreign body removal system 100 can further comprise a support member 604 (FIGS. 6-7). A support member 604 can be selectively, removably, or fixedly coupled with the base of an artificial eyeball 110. The support member 604 can be utilized to avoid handling and damage of an artificial eyeball 110 during installation and/or removal of the artificial eyeball 110 from the system 100. In some embodiments comprising a holding vessel 106 having tubular geometry (as shown in FIG. 2B), a support member 604 can be configured to couple with at least a portion of the holding vessel 106. In such embodiments, during installation of an artificial eyeball 110 a user can grasp a support member 604, rather than the artificial eyeball 110 to which it is coupled, and insert the support member 604/artificial eyeball 110 unit into a holding vessel 106. In other embodiments a support member 604 can be utilized in any other desired manner.

A support member 604 can have an inverted cup-like geometry, as depicted in FIGS. 6-7, or can be cylindrical, tubular, cuboid, or can have any other desired geometry. Moreover, a support member 604 can be comprised of plastic, silicone, polymer, metal, wood, and/or any other known and/or convenient material or combination of materials.

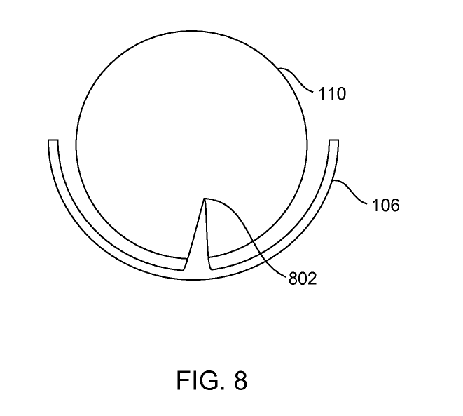

An artificial eyeball 110 can be coupled with a holding vessel 106 via friction fit, snap fit, hook and loop materials, adhesive, or any other desired attachment device. Moreover, as shown in the side cross-section view in FIG. 8, in some embodiments one or more sharp protrusions 802 can extend from the interior surface of a holding vessel 106. The sharp protrusion 802 can pierce the base of an artificial eyeball 110, engaging the artificial eyeball 110 in a secure position to prevent undesired movement.

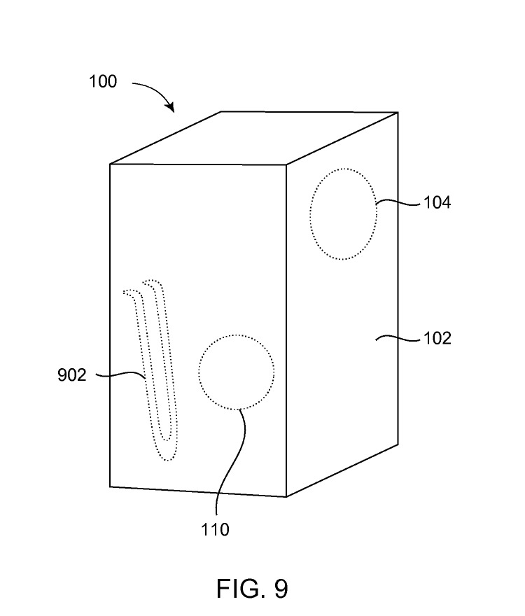

Referring to FIG. 9, in some embodiments, a foreign body removal system 100 can arrive at the end user as a complete kit for the practice of foreign body removal. In such instances, a retainer unit 102 can be hollow and can be configured to contain one or more artificial eyeballs 110, removal implements 902, and/or any other accessory or component. A user can then access the items through an aperture 104 or in any other desired manner.

Referring to FIGS. 3-4, in use, a retainer unit 102 can be mounted onto a biomicroscope 300 by placing the retainer unit 102 in an upright position between the headrest 302 and chinrest 304. The headrest 302 and chinrest 304 can then be moved toward one another and against the top and bottom ends of the retainer unit 102 until the retainer unit 102 is secured. If a holding vessel 106 is not already affixed to the retainer unit 102, the holding vessel 106 can be placed through an aperture 104 in the front surface of the retainer unit 102 and secured via frictional engagement. An artificial eyeball 110 containing foreign bodies 602 (see FIG. 6) can then be coupled with the interior surface of the holding vessel 106. Foreign body 602 removal can then be practiced by the user utilizing the biomicroscope 300 and removal implements such as a spud, syringe, and/or needle. Removal of the simulated rust rings, surface irregularity and stagnant corneal epithelial cells can be assisted with the use of an agar brush or diamond burr.

The foregoing method is just one embodiment of how the present foreign body removal system 100 can be utilized. The process of foreign body removal can be accomplished via any other known and/or convenient steps and/or utilizing any additional tools or devices. This system 100 can also be utilized for applications other than practicing removal of foreign bodies from human eyeballs, such as for practice of surgical or non-surgical procedures related to the eye or other human body part. In some embodiments, it may be desirable to utilize the system 100 in applications related to animal anatomy.

Although the foregoing system and method has been described in conjunction with specific embodiments thereof, it is evident that many alternatives, modifications and variations will be apparent to those having ordinary skill in the art.

What is claimed is:

1. A foreign body removal system comprising:
a retainer unit configured to be selectively coupled with a biomicroscope;
said retainer unit having a front surface and a back surface;
a holding vessel coupled with the front surface of said retainer unit; and
an artificial eyeball having a curved surface, said artificial eyeball being coupled with said holding vessel.

2. The foreign body removal system of claim 1, wherein said retainer unit has a substantially cuboid geometry and further comprises an aperture in its front surface, said aperture configured to accept at least a portion of said holding vessel.

3. The foreign body removal system of claim 1, wherein said artificial eyeball comprises at least one gelatinous material corresponding to at least one portion of human eyeball anatomy.

4. The foreign body removal system of claim 1, said artificial eyeball being embedded with at least one foreign body.

5. The foreign body removal system of claim 1, wherein the front surface of said retainer unit further comprises a covering, said covering being comprised of waterproof material.

6. The foreign body removal system of claim 1, further comprising at least one attachment member coupled with the back surface of said retainer unit.

7. The foreign body removal system of claim 6, wherein said at least one attachment member is chosen from the group consisting of: hook, adhesive, strap, buckle, hook and loop material, snap, and clamp.

8. The foreign body removal system of claim 1, wherein said holding vessel has a substantially hollow half-dome geometry and further comprises a sharp protrusion extending from its interior surface, said sharp protrusions being configured to engage the base of said artificial eyeball.

9. The foreign body removal system of claim 2, wherein said holding vessel is substantially tubular and further comprises at least one attachment point configured to mate with the edges of said aperture.

10. The foreign body removal system of claim 1, wherein said retainer unit is substantially planar and has a curved surface with at least one attachment member integrated with the top and bottom ends of said retainer unit.

11. The foreign body removal system of claim 1, wherein said retainer unit is at least partially comprised of elastomeric material.

12. The foreign body removal system of claim 1, wherein said retainer unit is hollow and configured to store removal implements.

13. A method of practicing foreign body removal from an eye, comprising:
providing an artificial eyeball comprising gelatinous material that simulates the anatomy of a human eyeball, said gelatinous material being embedded with at least one foreign body;
placing said artificial eyeball within a retaining unit mounted onto a biomicroscope;
viewing said artificial eyeball through said biomicroscope; and
removing said at least one foreign body from said artificial globe with one or more removal implements.

14. A foreign body removal kit, comprising:
a substantially hollow retainer unit configured to be selectively coupled with a biomicroscope;
at least one attachment member coupled with said retainer unit and configured to selectively couple with a biomicroscope;
a holding vessel coupled with said substantially hollow retainer unit via an aperture;
an artificial eyeball having a curved surface, said artificial eyeball being configured to selectively couple with said holding vessel; and
at least one removal implement;
wherein said substantially hollow retainer unit is configured to store said artificial eye member and said at least one removal implement when not in use.
